(19) United States
(12) Patent Application Publication
(10) Pub. No.: US 2026/0095537 A1
(43) Pub. Date: Apr. 2, 2026

(54) IMAGE READING APPARATUS

(71) Applicant: CANON KABUSHIKI KAISHA, Tokyo (JP)

(72) Inventor: AKIKO KANNO, Chiba (JP)

(21) Appl. No.: 19/336,624

(22) Filed: Sep. 23, 2025

(30) Foreign Application Priority Data
Sep. 27, 2024 (JP) 2024-169199

(51) Int. Cl. H04N 1/407; H04N 1/00

(52) U.S. Cl. CPC H04N 1/4072; H04N 1/00482; H04N 1/0071; H04N 1/00822; H04N 2201/0081

(57) ABSTRACT

An image reading apparatus includes a control unit configured to perform advance obtainment processing for obtaining correction data for shading correction by using a reading unit, in a state in which a document is placed on a document tray and before accepting a document read start instruction. The control unit includes, as operation modes for the advance obtainment processing, a first mode for obtaining the correction data by performing the advance obtainment processing using the second resolution in a case where the second resolution is designated as the reading resolution, and a second mode for obtaining the correction data by performing the advance obtainment processing using the first resolution in a case where the second resolution is designated as the reading resolution.

### BACKGROUND

### Field of the Technology

The present disclosure relates to an image reading apparatus.

### Description of the Related Art

In an image reading apparatus (document reading apparatus) including an auto document feeder (ADF), there is demand to shorten a first copy output time (FCOT), which is a time from a read start instruction until output of a first sheet, for example, in order to improve productivity of image reading processing. In the image reading apparatus, as a preparation operation for starting processing for reading a plurality of documents by feed scanning, a reference white plate in the apparatus is read, and processing for obtaining correction data for shading correction is performed. Japanese Patent Laid-Open No. 2011-023990 discloses a technique for reducing FCOT by performing processing for obtaining correction data for shading correction in advance before the start of job execution.

A reading resolution at the time of obtaining correction data for shading correction normally needs to match a reading resolution at the time of reading a document. If a different reading resolution is designated at the start of job execution after obtaining correction data, the processing for obtaining correction data needs to be performed again, which results in a longer FCOT. Japanese Patent Laid-Open No. 2021-087148 describes a technique in which, when a change of a resolution setting is instructed, the change is notified without waiting for the start of job execution, and processing for obtaining correction data for shading correction is performed in advance.

In the image reading apparatus, a document may be read with the reading resolution at the time of reading the document set (changed) to a higher resolution than the designated reading resolution. In such a case, the reading resolution of the correction data for shading correction obtained by performing the obtainment processing at the designated reading resolution may be different from the reading resolution of the data obtained by reading the document.

### SUMMARY

The present disclosure provides a technique that allows a reading resolution to be used in processing for obtaining correction data for shading correction to be set appropriately.

According to one aspect of the present disclosure, there is provided an n image reading apparatus comprising: a reading unit configured to be capable of setting at least a first resolution and a second resolution, which is lower than the first resolution, as a reading resolution for reading a document conveyed from a document tray, and read a document at a set reading resolution; and a control unit configured to perform advance obtainment processing for obtaining correction data for shading correction by using the reading unit, in a state in which a document is placed on the document tray and before accepting a document read start instruction, wherein the control unit includes, as operation modes for the advance obtainment processing, a first mode for obtaining the correction data by performing the advance obtainment processing using the second resolution in a case where the second resolution is designated as the reading resolution, and a second mode for obtaining the correction data by performing the advance obtainment processing using the first resolution in a case where the second resolution is designated as the reading resolution.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a perspective view illustrating an example of a configuration of an image reading apparatus.

FIG. 2 is a cross-sectional view illustrating an example of a configuration of the image reading apparatus.

FIG. 3 is a block diagram illustrating an example of a control configuration of the image reading apparatus.

FIG. 4 illustrates an example of a configuration of an operation unit.

FIGS. 5A and 5B illustrate an example of shading correction.

FIGS. 6A to 6D illustrate an example of an operation screen to be displayed on the operation unit.

FIG. 7A illustrates an example of read setting notification data.

FIG. 7B illustrates an example of read start instruction data.

FIG. 8 is a flowchart for explaining an example of a procedure for image reading processing.

FIG. 9A is a flowchart for explaining an example of a procedure for advance obtainment processing.

FIG. 9B is a flowchart for explaining an example of a procedure for resolution setting processing.

FIGS. 10A to 10D are views for explaining skew detection.

FIGS. 11A and 11B are views for explaining skew correction.

FIG. 12 is a view for explaining a relationship between skew correction and resolution.

FIG. 13 is a flowchart for explaining an example of a procedure for processing of step S102 (second embodiment).

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

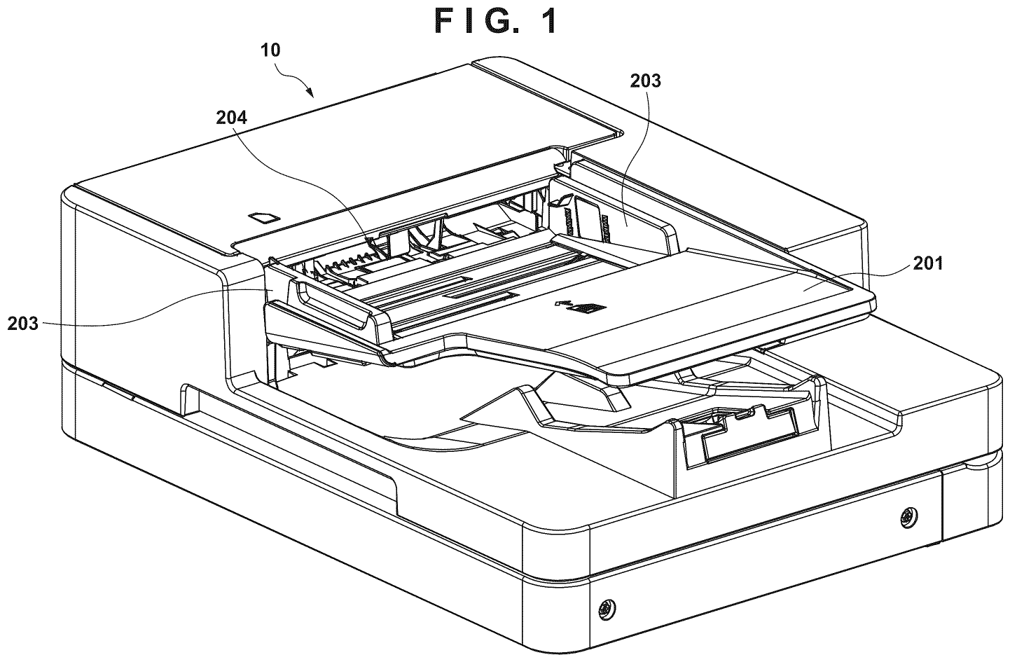

FIG. 1 is a perspective view illustrating an example of a configuration of an image reading apparatus according to a first embodiment. An image reading apparatus (document reading apparatus) 10 according to the present embodiment includes an image reading unit (reader) 100, which reads a document, and an auto document feeder (ADF) 200, which conveys a document towards the reader 100.

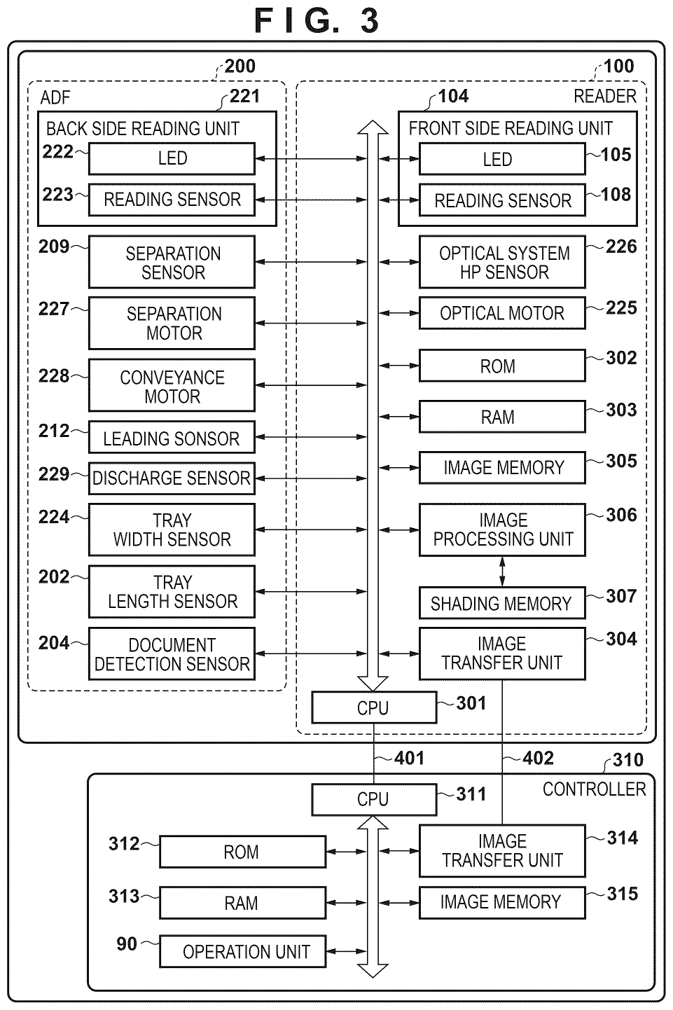

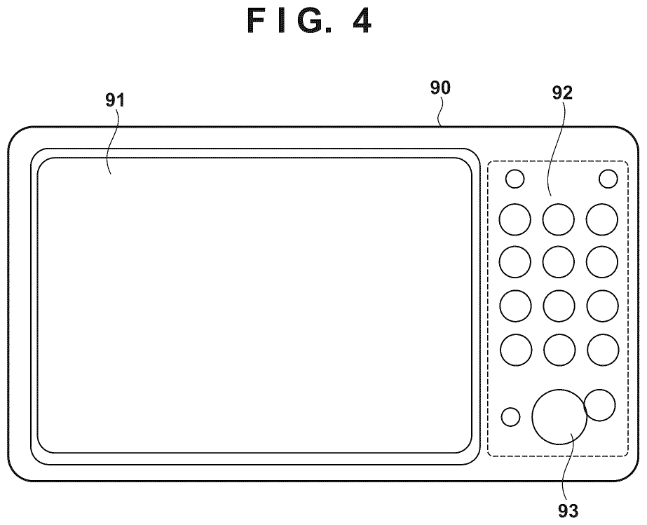

The image reading apparatus 10 further includes an operation unit 90 (FIG. 4). The operation unit 90 includes a display unit 91 and an operation key group 92, which includes a start key (start button) 93. Further, the image reading apparatus 10 further includes a controller 310 (FIG. 3) as a control unit that controls the entire apparatus.

### <Example of Configuration of Reader 100>

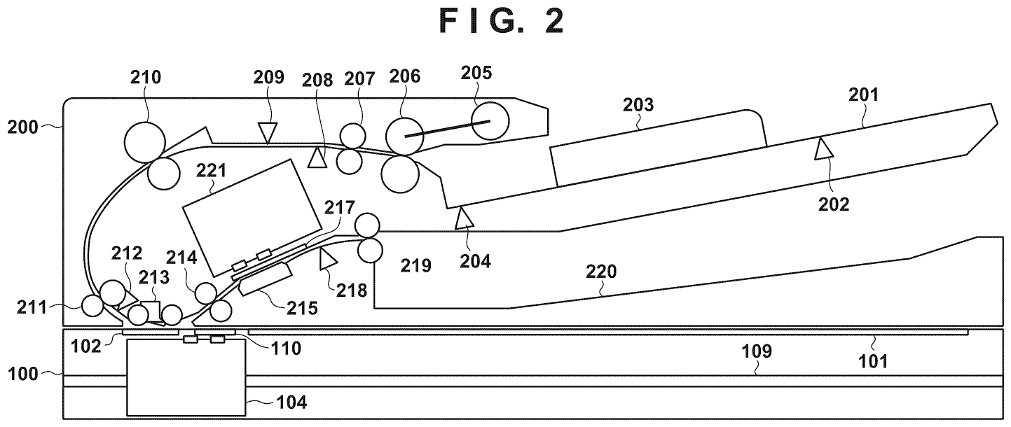

FIG. 2 is a cross-sectional view illustrating an example of a configuration of the image reading apparatus 10. The reader 100 includes a document platen glass 101, a feed reading glass 102, a front side reading unit 104 including a front side LED 105 (FIG. 3) and a front side reading sensor 108 (FIG. 3), a white reference plate 110 used in processing for obtaining correction data for shading correction, and an optical motor 225 (FIG. 3). At the time of document reading control, the reader 100 reads an image of a document by reading the front side of the document placed on the document platen glass 101 one line at a time, while moving the front side reading unit 104 along a reading movement guide 109 by using the optical motor 225. Further, at the time of feed reading control, an image of a document conveyed just above the feed reading glass 102 by the ADF 200 is read by the front side reading unit 104.

### <Example of Configuration of ADF 200>

As illustrated in FIG. 2, the ADF 200 includes a document tray 201 for placing a document bundle S constituted by one or more document sheets and, as a separation mechanism, a separation roller pair 206 and a pick-up roller 205 for preventing the document bundle S from protruding beyond the document tray 201 and entering downstream before the start of document conveyance.

Furthermore, a document detection sensor 204 for detecting a document stacked on the document tray 201, a separation sensor 209 for detecting front and trailing edges of a document on a sheet conveyance path, a leading sensor 212, and a discharge sensor 218 are connected. In addition, a tray width guide sensor 224, which detects a document width regulated by a tray width guide plate 203 on the document tray 201, and a tray length sensor 202, which can detect an approximate length of the document bundle placed on the document tray 201 in a sub-scanning direction, are connected.

In the ADF 200, a separation motor 227 (FIG. 3) and a conveyance motor 228 (FIG. 3) are rotated to drop the pick-up roller 205 on the uppermost surface of the document bundle S stacked on the document tray 201 and rotate the pick-up roller 205. With this, a document on the uppermost surface of the document bundle is fed to the separation roller pair 206. Regarding the document fed by the pick-up roller 205, a single sheet on the uppermost surface is separated by an action of the separation roller pair 206 driven by the separation motor 227, similarly to the pick-up roller 205, and conveyed. The document separated by the separation roller pair 206 is fed to a conveyance roller pair 207 driven by the conveyance motor 228. After the start of document conveyance by the conveyance roller pair 207, the separation motor 227 is stopped, and document feeding ends.

A conveyance path that conveys a document that has passed through the conveyance roller pair 207 towards a front side feed reading glass 102 and a back side feed reading glass 217 is disposed on the downstream side of the conveyance roller pair 207. The document fed to the conveyance path is conveyed by the conveyance roller pair 207 and a read upstream roller pair 211 to the front side feed reading glass 102. In the case of front side reading, a document passing through the front side feed reading glass 102 is illuminated by the front side LED 105 from under the front side feed reading glass 102. By reading its reflection light by the front side reading sensor 108 at a front side reading position 213, a front side image of the document is inputted.

Further, the ADF 200 includes the back side feed reading glass 217, a back side reading unit 216 including a back side LED 222 (FIG. 3) and a back side reading sensor 223 (FIG. 3), and a back side white reference plate 215 used in processing for obtaining correction data for shading correction. In the case of double-sided reading, the front side is read by the front side reading unit 104, similarly to the above description. A document whose front side has been read by the front side reading unit 104 is conveyed to the back side feed reading glass 217 by a read downstream roller pair 214. Then, the document passing under the back side feed reading glass 217 is illuminated by the back side LED 222 (FIG. 3) from above the back side feed reading glass 217. By reading its reflection light by the back side reading sensor 223 through a back side mirror and lens (not illustrated), a back side image of the document is inputted. The read document is directly discharged onto a discharge tray 220 by a discharge roller pair 219.

The front side reading unit 104 and the back side reading unit 216 may be constituted by a direct optical system in which a lens array is used, in addition to the above reduction optical system.

### <Control Configuration>

FIG. 3 is a block diagram illustrating an example of a control configuration of the image reading apparatus 10. A CPU 301 controls each unit of the reader 100 and the ADF 200 in a comprehensive manner. A ROM 302 is a storage apparatus that stores contents of control to be executed by the CPU 301 as a program. A RAM 303 is a storage apparatus used as a work region necessary for the CPU 301 to perform control.

The separation motor 227 and the conveyance motor 228, which drive respective rollers for conveyance, are connected to the CPU 301 in order to realize a document conveyance function. The separation motor 227 is connected to the pick-up roller 205 and the separation roller pair 206.

In the present embodiment, the separation motor 227 and the conveyance motor 228 are pulse motors. The CPU 301 controls the rotation amount of each motor by controlling the number of driving pulses. Based on the number of pulses, the CPU 301 measures a conveyance distance of a document being conveyed and controls each load and the like to convey the document.

Further, the separation sensor 209, the leading sensor 212, and the discharge sensor 218, which detect an edge of a document on a sheet conveyance path, are connected to the CPU 301. In addition, the document detection sensor 204 for detecting a document stacked on the document tray 201, the tray width guide sensor 224 for detecting a document width regulated by the tray width guide plate 203 on the document tray 201, and the tray length sensor 202 are connected to the CPU 301.

The optical motor 225 for moving the front side reading unit 104 in the sub-scanning direction, an optical system HP sensor 226, an image memory 305, an image processing unit 306, and an image transfer unit 304 are respectively connected to the CPU 301 in order to realize an image reading function. The front side reading unit 104 includes the front side LED 105, which is a light source, and the front side reading sensor 108, which is a line sensor. A conveyed document is illuminated by the LED 105, which is a light source, on a side to be read, and reflected light is photoelectrically converted one line at a time by light receiving elements of the front side reading sensor 108 and read as image data. The back side reading unit 216 includes the back side LED 222, which is a light source, and the back side reading sensor 223, which is a line sensor. A conveyed document is illuminated by the back side LED 222, which is a light source, on a side to be read, and reflected light is photoelectrically converted one line at a time by light receiving elements of the back side reading sensor 223 and read as image data, similarly to the front side. The image memory 305 is a storage apparatus that temporarily stores image data read by the front side reading unit 104 and the back side reading unit 216.

The image processing unit 306 corrects the read image stored in the image memory 305 by image processing. A shading memory 307 is connected to the image processing unit 306 and holds shading correction data, which will be described later. Further, the CPU 301 can read from and write to the shading memory 307 via the image processing unit 306. The image transfer unit 304 transfers image data subjected to image processing by the image processing unit 306 to an image transfer unit 314 of the controller 310, which will be described later, via an image transfer line 402.

### <Controller>

The controller 310 controls the entire image reading system, which includes the reader 100 and the ADF 200. A CPU 311 controls each unit of the controller 310 in a comprehensive manner. A ROM 312 is a storage apparatus that stores contents of control to be executed by the CPU 311 as a program. A RAM 313 is a storage apparatus used as a work region necessary for the CPU 311 to perform control.

The image transfer unit 314 receives an image from the image transfer unit 304 and stores it in an image memory 315. The operation unit 90 is for instructing operations for the entire image reading system from the user and for displaying a message to the user and displaying a read image, and communicates with the CPU 311 to perform desired display and input.

The CPU 311 communicates control commands related to image reading control and exchanges control data via a communication line 401 with the CPU 301. For example, the CPU 311 receives the user's image read job start instruction from the operation unit 90 and transmits an image reading start request to the CPU 301. For example, the CPU 311 receives information such as a monochrome or color reading instruction, a reading resolution, a reading document size, and a read job start instruction from the operation unit 90 by using the operation key group 92, and transmits control information such as a document feeding start instruction and a document reading instruction to the CPU 301. The document feeding start instruction includes a reading resolution, and a document reading instruction includes information on a reading document size. Further, the CPU 311 receives the state of the document reading apparatus 10 from the CPU 301 and displays a message to the user that accords with the state of the apparatus on the operation unit 90.

### <Operation Unit>

FIG. 4 illustrates an example of a configuration of the operation unit 90. The operation unit 90 includes the display unit 91 and the operation key group 92, which includes a numeric keypad and the start button 93. The start button 93 is used to input an image reading processing start instruction. The CPU 311 displays a message to the user or an operating screen on the display unit 91 and accepts input of an instruction from the user.

### <Processing for Obtaining Correction Data for Shading Correction>

The front side white reference plate 110 and the back side white reference plate 215 are white reference plates for creating white level correction data to be used for shading correction. Before the start of document reading, the front side white reference plate 110 and the back side white reference plate 215 are read by the front side reading unit 104 and the back side reading unit 216, respectively, and image processing is performed on the reading result to create correction data for shading correction.

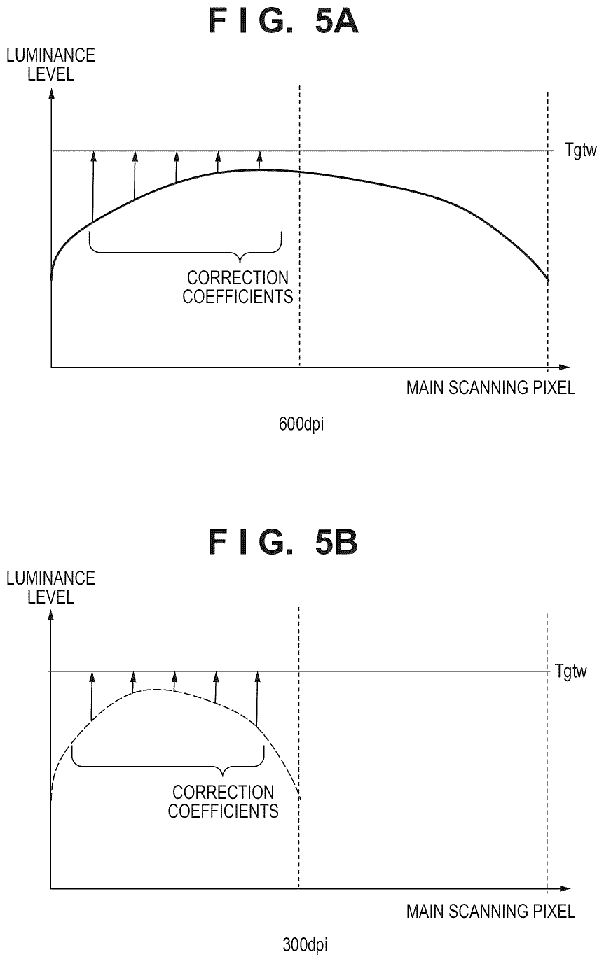

In shading correction in the front side reading unit 104, the front side white reference plate 110 is read. FIG. 5A and FIG. 5B illustrate an example of luminance values of a read white reference plate and shading correction. FIG. 5A is an example of a case where a reading resolution in the main scanning direction is set to 600 dpi. A correction factor is calculated for each pixel such that a difference of a reading level for each pixel is corrected to a fixed white level Tgtw as illustrated in the drawing. The correction factor corresponds to an arrow portion illustrated in the same drawing. The correction coefficient corresponds to the correction data for shading correction, and the obtained correction data is stored in the shading memory 307. The correction coefficients are similarly calculated for the back side reading unit 216 and stored in the shading memory 307 for the back side. The correction data is constituted by data that includes correction factors for the number of pixels in the main scanning direction for each of the three primary colors (R, G, B) of the light source. At the time of document reading, each time one line is read, the image processing unit 306 corrects the one line of read image by using the correction coefficients (correction data) stored in the shading memory 307, and thereby generates image data of the read image after shading correction. The generated image data is stored in the image memory 305.

FIG. 5B is an example of shading correction in a case where a reading resolution in the main scanning direction is set to 300 dpi. When reading an image of the same width, the number of pixels in the main scanning direction is ½ of the number of pixels in 600 dpi. Therefore, as illustrated in the drawing, the characteristics of correction coefficients in the main scanning direction has a different shape from that at 600 dpi, and shading correction coefficients in 600 dpi cannot be used as is for image reading processing in 300 dpi. Therefore, it is necessary to match the reading resolution applied to the processing for obtaining correction data for shading correction with the reading resolution applied at the time of actual document reading.

<Processing for Detecting Skew from Read Image>

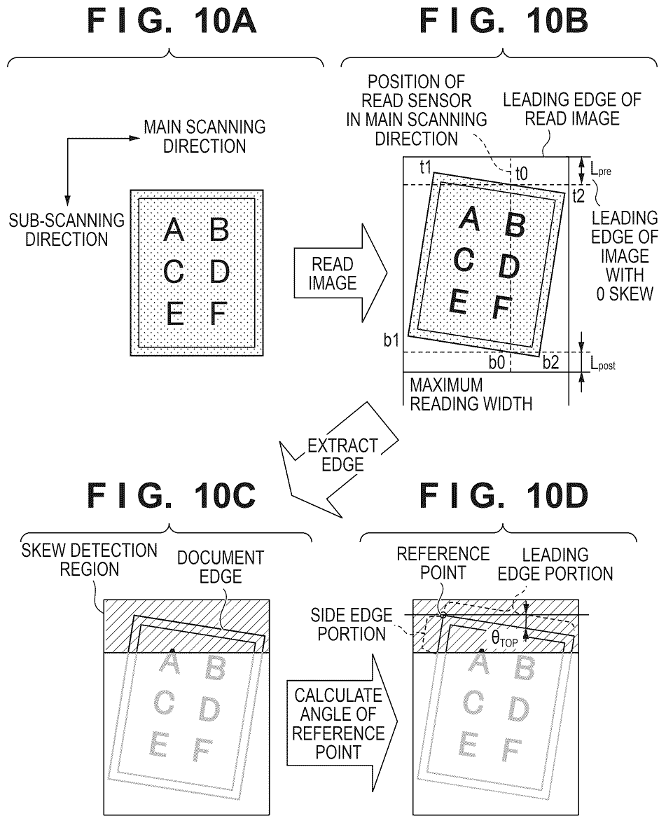

Skew detection processing for detecting an amount of skew of a document at the time of conveyance from a read image will be described. FIGS. 10A to 10D are explanatory views illustrating a method of detecting skew of a document from a read image. FIG. 10A is a document to be read. FIG. 10B illustrates a read image obtained by reading the front side of the document of FIG. 10A by feed reading. When reading a document image by the front side reading unit 104, a region greater than the size of the document is read in advance as in FIG. 10C, in view of the possibility that the document may be skewed. Specifically, the reading region is expanded such that the entire document can be read even if it is skewed to the maximum allowable amount for the auto document feeder. The main scanning width of the reading region is fixed at the maximum width that can be read by the front side reading unit 104 and the back side reading unit 216. The sub-scanning reading region is determined by the on/off timing of the leading sensor 212.

The leading sensor 212 is disposed approximately in the center in the main scanning direction. In FIG. 2, the distance between the leading sensor 212 and the front side reading position 213 is set to be L. If the document is not skewed, by conveying it by a distance L from the timing when it is detected that the leading sensor 212 is on (document is present) and then starting image reading, the reading can be started from the leading edge of the document. However, if the document is skewed, then when measured by the leading sensor 212, the document leading edge timing matches the read start position at position t0 corresponding to the sensor position in FIG. 10B, but at position t1 where the document has been conveyed the earliest due to skewing, the leading edge of the document has already passed by. Therefore, if reading starts from position to, the image of the t1 portion will be missing. Therefore, as in FIG. 10B, the CPU 301 starts reading an image after the leading sensor 212 is turned on and when the document is conveyed for a conveyance distance (L−Lpre) to the position just before a leading edge skew detection margin Lpre, instead of the distance L. Thus, the document is read without missing its leading edge.

It is similar for the trailing edge side of the document. When the document is conveyed by the distance L from the timing when its trailing edge reaches the leading sensor 212 and it is detected that the sensor is off (document is not present), the trailing edge of the document aligns with the reading end timing at position b0 corresponding to the sensor position in the main scanning direction. However, at position b2 where conveyance is the most delayed due to skewing, the trailing edge of the document has not yet passed through the reading position, and if the reading is ended, an image of the b2 portion will be missing. Therefore, as in the drawing, the CPU 301 stops reading an image after the leading sensor 212 is turned off and when the document is conveyed for a conveyance distance (L+Lpost) to the position just after a trailing edge skew detection margin Lpost, instead of the distance L. With this, the reading of the document is ended after arrival, and thus, the document can be read without missing its trailing edge.

The image processing unit 306 performs skew detection processing on the read image of the entire document thus obtained. When a document is read, a shadow occurs on the outside of an edge of the document due to the thickness of the document itself. This shadow is detected to determine the leading edge of the document, and a skew amount is calculated.

FIG. 10C is an edge extraction result in a skew detection region indicated by hatching in the read image of FIG. 10B. FIG. 10D illustrates the leading edge of the document determined from an edge extracted in FIG. 10C and a skew amount. As illustrated in FIGS. 10C and 10D, among the edges extracted from the skew detection region, continuous edges closest to the leading edge of the document are detected as a leading edge portion and a side edge portion of the document, and a leading edge skew amount θ_{TOP} is calculated from an angle formed by the main scanning direction and the leading edge portion of the document. Further, the coordinates of a reference point indicating the position of the document are calculated from an intersection of the leading edge portion and the side edge portion. The coordinates of the reference point are used as a reference for rotation processing at the time of skew correction. The document width is detected from the length of the leading edge portion of the document.

After performing the skew detection processing, the image processing unit 306 holds the leading edge skew amount and the coordinates of the reference point described above in the RAM 303.

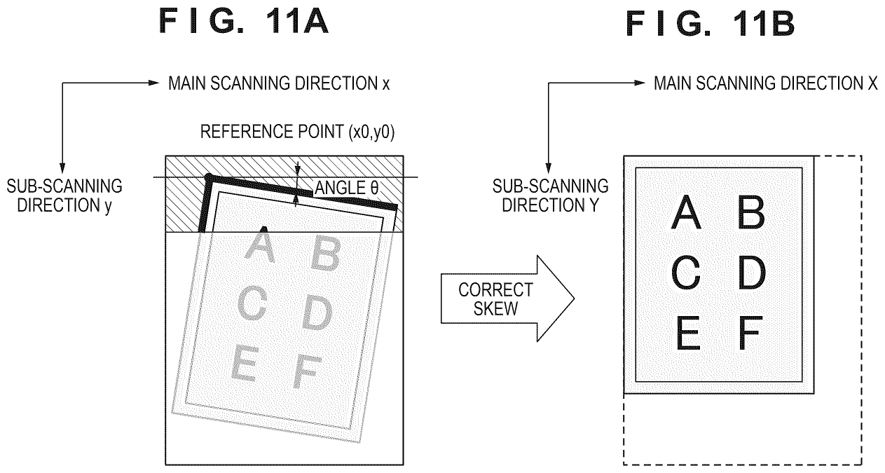

FIGS. 11A and 11B are views illustrating a method of correcting skew of a document from a read image. FIG. 11A illustrates a read image obtained by reading the front side of a document by feed reading, and FIG. 11B illustrates an image after skew correction. In skew correction processing, skew is corrected by rotating the image about the reference point.

The image processing unit 306 calculates, in accordance with the following equation, the positions (main scanning (X), sub-scanning (Y)) of the pixels for correcting the image by rotating the image by the skew correction amount θ, which corresponds to the skew amount, about the above reference point. x0 and y0 are movement amounts for translating data that has been subjected to skew correction with the reference point as the rotational center, and are calculated from the reference point coordinates and the skew correction amount. This makes it possible to align the output positions of the leading edge portion and the side edge portion of the image.

$$X = x cos θ - y sin θ - x 0$$

$$Y = x sin θ + y cos θ - y 0$$

X: pixel position after correction in the main scanning direction; Y: pixel position after correction in the sub-scanning direction
x: pixel position before correction in the main scanning direction; y: pixel position before correction in the sub-scanning direction
x0: translation amount in the main scanning direction (main scanning skew correction reference position)
y0: translation amount in the sub-scanning direction (sub-scanning skew correction reference position)
θ: skew correction amount based on skew calculated from the leading edge portion of the document

In the present embodiment, skew is detected based on a shadow at the leading edge portion of the document and skew is corrected by image rotation, but the present invention is not limited to this method, and another method may be used as long as it is a method in which the position of the rotation center and the skew angle are obtained.

### <Setting Mode at Time of Reading Document Having Narrow Width>

An example of reading a document having a narrow width will be described. A document having a width narrower than a predetermined width, such as a receipt or a business card, is difficult to regulate during conveyance even if the document is held by the tray width guide plate 203 of the document tray 201 when placed on the document tray 201. Further, since the document is small and the surface area where the document during conveyance comes into contact with each roller in the apparatus is also small, the document is more likely to skew.

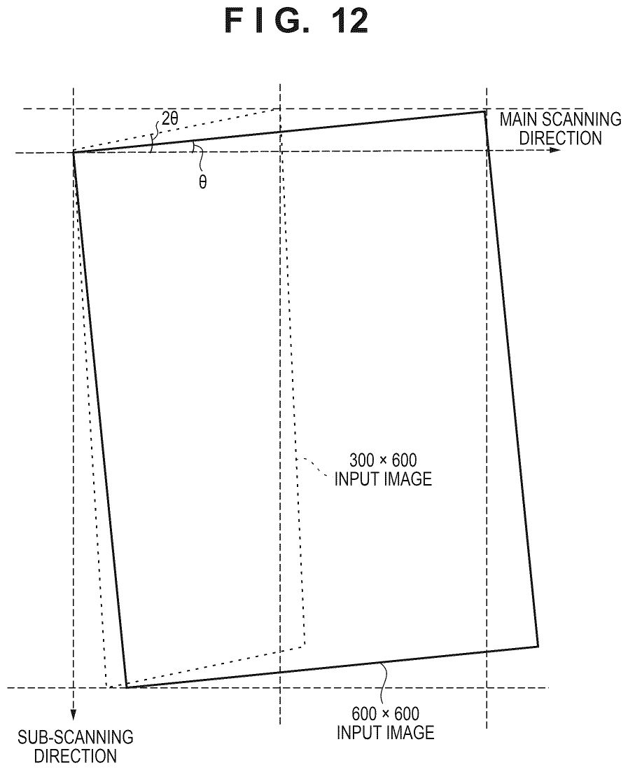

FIG. 12 is a view for explaining a relationship between a resolution and an effective angle for skew correction. An example of a skew detection result when a document having the same skew angle is read at a sub-scanning resolution of 600 dpi and a main scanning resolution of 300 dpi and 600 dpi, respectively, will be described.

In the case of main scanning at 300 dpi (dotted line in the drawing), since only the main scanning direction is compressed to ½, the leading edge skew amount θ_{TOP} is detected to be 2θ, which is double the actual angle θ (solid line in the drawing) at the time of main scanning and sub-scanning at 600 dpi. Since there is an upper limit on angles that can be corrected, when the angle is detected to be double, the range of angles that can actually be corrected for skewing is narrowed by half. For example, when the correction upper limit is 5°, if main scanning is inputted at 300 dpi, even if the actual skew is 3°, the detected angle will be 6°, which exceeds 5°, and thus cannot be fully corrected. Therefore, in functions or modes where skew is expected to be large, it is desirable to input an image at a high resolution in order to make the range of angles that can be corrected as large as possible.

In addition, in a conveyance operation, in order to perform a reading operation at a high resolution, it is generally necessary to set the conveyance speed to be slower than in the case of a low resolution. Lowering the conveyance speed can be expected to improve skew.

Therefore, when it is determined that the width of a document regulated by the tray width guide plate 203 and detected by the tray width guide sensor 224 is narrower than a predetermined threshold, even if a resolution of 300 dpi is designated from the controller, the reading operation is executed at a reading resolution of 600 dpi, and the resolution is converted into 300 dpi at the time of transferring the image to the controller 310 and transferred. When the resolution instructed from the controller is 600 dpi, the reading operation is normally performed at 600 dpi regardless of the width of the document, and transfer is made with the resolution as is.

### <Example of Operation Screen>

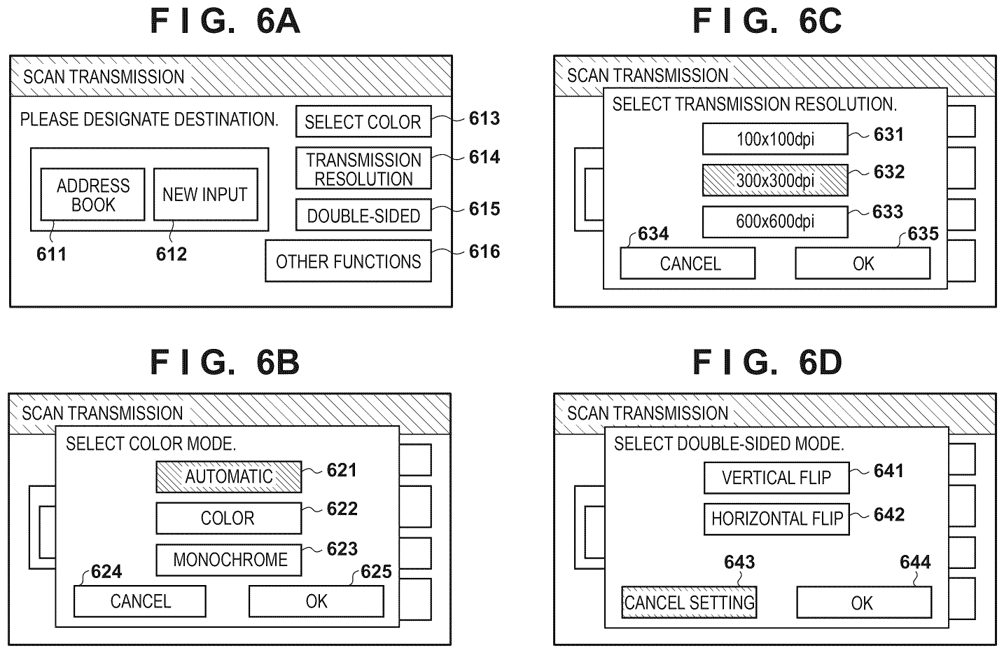

FIGS. 6A to 6D are views illustrating an example of a screen flow for the CPU 311 notifying the CPU 301 of a resolution instruction for starting the processing for obtaining correction data based on input on the operation unit 90.

FIG. 6A is a view illustrating an example of a top screen for setting various scan transmission modes. Buttons for setting a reading color mode selection 613, a transmission resolution 614, and a double-sided function 615 as basic settings are disposed. Settings other than the basic settings can be further selected by pressing other functions 616. A destination can be selected from an address book (not illustrated) displayed by an address book button 611, or a new destination can be set from a new input button 612.

FIG. 6B illustrates an example of a screen displayed by pressing the reading color mode selection button 613. An automatic determination button 621, a color button 622, and a monochrome button 623 are arranged as options that can be designated on this screen, and the state is that in which the automatic determination is selected as a default setting. After selecting a desired mode, the reading color mode is confirmed by pressing an OK button 625. Further, it is possible to cancel the setting change by pressing a cancel button 624.

FIG. 6C is an example of a screen displayed by pressing the transmission resolution button 614. A 100×100 dpi button 631, a 300×300 dpi button 632, and a 600×600 dpi button 633 are arranged as transmission resolutions that can be designated, and the state is that in which 300×300 dpi is selected as a default setting. After changing the transmission resolution, it is possible to either confirm the transmission resolution with an OK button 365 or cancel the setting change by pressing a cancel button 634.

FIG. 6D is an example of a screen displayed by pressing the double-sided button 615. A vertical flip button 641 and a horizontal flip button 642 are disposed as double-sided modes that can be designated. The state is that in which neither is selected in a default setting. In this state, a single-sided mode is assumed. After changing the double-sided mode, it is possible to either confirm the double-sided mode with an OK button 644 or cancel the setting change by pressing a cancel button 643.

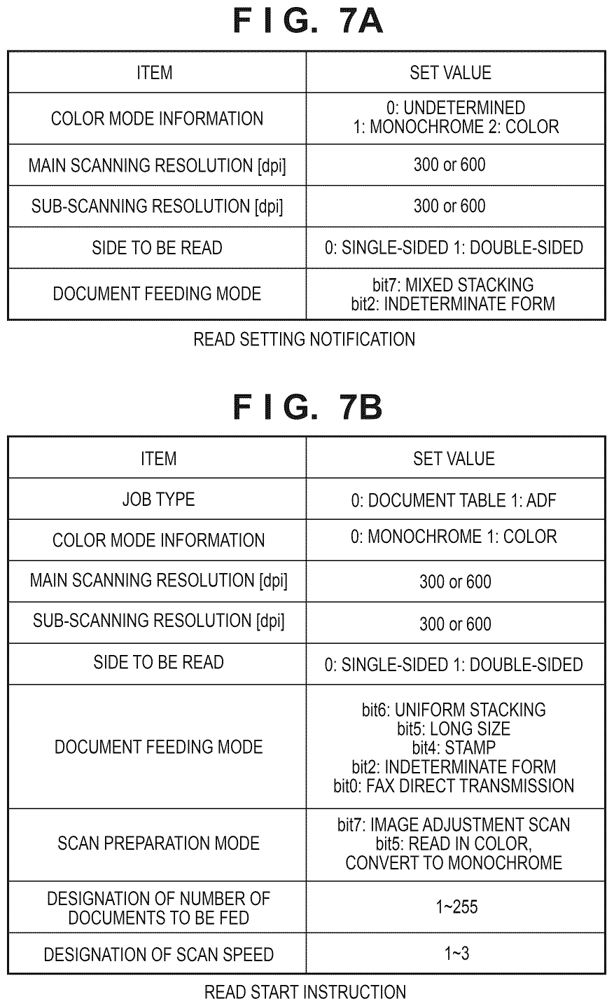

In the present embodiment, the CPU 311 of the controller 310 transmits a read setting notification including read settings to the CPU 301 of the reader 100 each time a respective above operation screen (setting screen) is operated by the user. FIG. 7A illustrates an example of read settings included in a read setting notification. For setting items that have not been set using the buttons in the respective screens, a default setting (initial setting) is included in the read setting notification.

Further, when the start button 93 of the operation unit 90 is pressed, the CPU 311 transmits a read start instruction for causing the reader 100 to start a document reading operation to the CPU 301. FIG. 7B illustrates an example of read settings included in a read start instruction.

### <Processing Procedure>

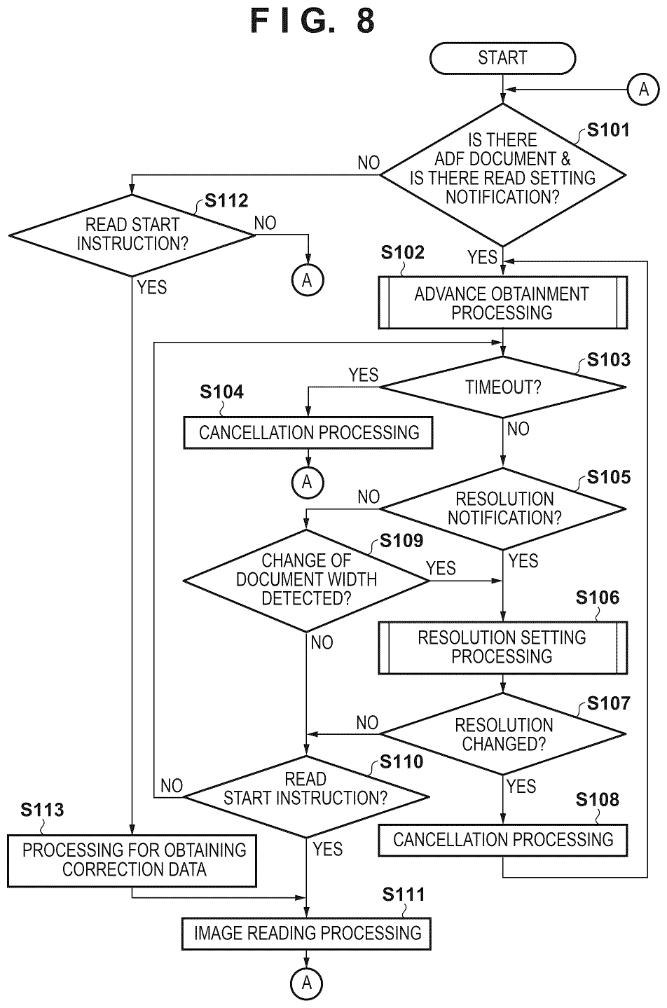

FIG. 8 is a flowchart for explaining an example of a procedure for image reading processing executed by the CPU 301 of the reader 100.

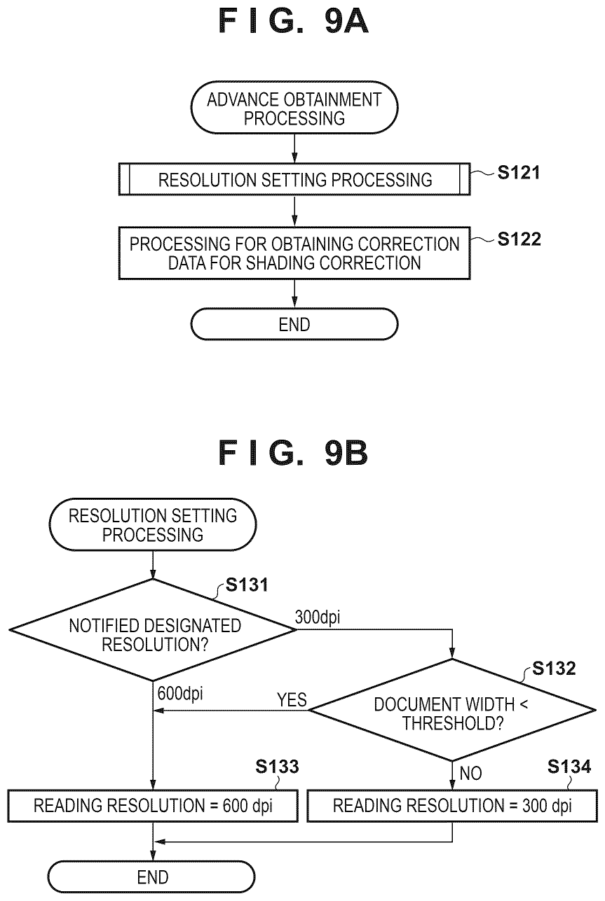

While the image reading apparatus 10 is in a standby state, the CPU 301 determines whether a read setting notification has been received from the CPU 311 in a state in which the document detection sensor 204 is detecting a document stacked on the document tray 201 (step S101). Upon receiving a read setting notification, the CPU 301 advances the processing to step S102 and executes advance obtainment processing (step S103) for obtaining correction data for shading correction in accordance with a procedure, which will be described below with reference to FIG. 9A, with read settings included in the read setting notification. After the advance obtainment processing is completed, the image reading apparatus 10 transitions to a read start instruction standby state.

If a timeout occurs due to a predetermined time elapsing without receiving a read start instruction from the CPU 311 in the read start instruction standby state (YES in step S103), the CPU 301 executes cancellation processing (step S104), which includes processing for discarding the obtained correction data, and returns the processing to step S101. Thus, the image reading apparatus 10 returns to the standby state.

If the CPU 301 receives a read setting notification again from the CPU 311 in the read start instruction standby state (YES in step S105), the CPU 301 executes resolution setting processing based on the most recent read setting included in the received notification (step S106). If it is determined that the reading resolution setting needs to be changed as a result of executing the resolution setting processing (YES in step S107), the CPU 301 executes cancellation processing (step S108), which includes processing for discarding the obtained correction data, and returns the processing to step S102. Thus, the CPU 301 obtains new correction data by performing the advance obtainment processing again based on a newly received read setting notification.

Here, as described above, it is desirable that the image reading processing is performed with a higher-resolution read setting for a document that is prone to skewing. Here, a case where a document whose width in the main scanning direction is narrower than a predetermined threshold is read after the resolution is changed will be described.

In FIG. 2, when the user places a document having a narrow width on the document tray 201, the tray width guide plate 203 is set to match the width of the document, allowing the CPU 301 to obtain the width of the document based on the output of the tray width guide sensor 224.

The following cases are assumed as conditions for executing the advance obtainment processing (step S102) based on the determination of step S101.

Case 1 is a case where the user places a document on the document tray 201 and aligns the tray width guide plate 203, and then executes settings from the operation unit 90. The CPU 301 receives a read setting notification in a state in which the document detection sensor 204 has been turned on in advance. In this case, since the value of the tray width guide sensor 224 has already been determined at the start of the advance obtainment processing, the document width can be determined.

Case 2 is a case where the user inputs various settings from the operation unit 90, and then places a document on the document tray 201 and aligns the tray width guide plate 203. The CPU 301 receives a read setting notification in a state in which the document detection sensor 204 is off, and then detects that the document detection sensor 204 has changed to on. In this case, two patterns can be assumed depending on how the document is placed:
settings for the tray width guide plate 203 are completed before the document detection sensor 204 changes to being on.
settings for the tray width guide plate 203 are completed after the document detection sensor 204 changes to being on.

In the former case, the document width has already been determined at the start of the advance obtainment processing, as in case 1. Meanwhile, in the latter case, at the time the document detection sensor 204 changes to being on and the advance obtainment processing is started, there is a possibility that the value of the tray width guide sensor 224 has not yet been determined. For example, assume that the value of the tray width guide sensor 224 at the start of the advance obtainment processing is greater than a predetermined threshold, and then, the value of the tray width guide sensor 224 is determined to be a value smaller than the predetermined threshold. In this case, since the document has a narrow width, the reading resolution may need to be changed, and the read settings necessary for the actual reading operation may change from the read settings in the advance obtainment processing.

Therefore, in the read start instruction standby state after completion of the advance obtainment processing (correction data obtainment processing), it is determined whether the document width assumed from the value of the tray width guide sensor 224 has changed from that at the start of advance obtainment processing (step S109). If the document width is changed (YES in step S109), even if no new read setting notification is received, it is determined whether the current reading resolution setting needs to be changed due to a change in the document width (step S107). If the reading resolution needs to be changed (YES in step S107), after execution of processing for cancelling the advance obtainment processing (step S108), the standby state is not returned to, and the advance obtainment processing is executed again with the reading resolution setting determined based on the most recent document width (step S102).

If a read start instruction is received from the CPU 311 in the read start instruction standby state (YES in step S110), the image reading apparatus 10 transitions to a reading-in-progress state, and the CPU 301 starts executing the image reading processing. When the image reading processing is completed, the CPU 301 returns the processing to step S101, and the image reading apparatus 10 returns to the standby state.

If a read start instruction is received (YES in step S112) in a state in which no read setting notification is received (NO in step S101) in the standby state, since corresponding advance obtainment processing has not been performed, the CPU 301 executes processing for obtaining correction data for shading correction (step S113) in accordance with the read settings included in the read start instruction, and then executes the image reading processing (step S111).

### <Advance Obtainment Processing>

FIG. 9A is a flowchart for explaining an example of a procedure for advance obtainment processing (step S102). When the advance obtainment processing is executed, an operation mode for the advance obtainment processing, including the resolution, is determined (step S121) based on mode data received in the read setting notification, and the processing for obtaining correction data for shading correction is performed in accordance with the determined settings (step S122). Regarding the resolution setting processing (step S121), executed operations are the same as in the processing of step S106 in FIG. 8.

FIG. 9B is a flowchart for explaining an example of a procedure for resolution setting processing (steps S106 and S121). In the present embodiment, the CPU 301 includes at least a first mode and a second mode as operation modes for the advance obtainment processing. The first mode is an operation mode in which, when a second resolution is designated as the reading resolution by the user, correction data is obtained by performing the advance obtainment processing using the second resolution. The second mode is an operation mode in which, when the second resolution is designated as the reading resolution by the user, correction data is obtained by performing the advance obtainment processing using a first resolution. In the following examples, a reading resolution setting in step S134 corresponds to a setting according to the first mode, and a reading resolution setting in step S133 corresponds to a setting according to the second mode.

The CPU 301 confirms the reading resolution (designated resolution) in the main scanning direction notified in the read setting notification (step S131). If the designated resolution is 600 dpi (first resolution), the CPU 301 sets the reading resolution to be used in the advance obtainment processing to 600 dpi, which is the same as the notified resolution, regardless of the document width.

Meanwhile, when the designated resolution is 300 dpi (second resolution), the CPU 301 detects the width of the document placed on the document tray 201 by using the tray width guide sensor 224 on the assumption that the tray width guide plate 203 is aligned with the document. If the document width is below a predetermined threshold (e.g., 100 mm) (YES in step S132), the CPU 301 performs a setting for changing the reading resolution to be used in the advance obtainment processing from 300 dpi (second resolution) to 600 dpi (first resolution). Further, if the document width is greater than or equal to the predetermined threshold (e.g., 100 mm) (NO in step S132), the CPU 301 sets the notified designated resolution as the reading resolution to be used in the advance obtainment processing. The CPU 301 executes the advance obtainment processing by using the reading resolution in the main scanning direction that has been set in the resolution setting processing.

The correction data obtained by the advance obtainment processing and stored in the shading memory 307 is used for shading correction for a read image. For example, the image processing unit 306 is configured to perform shading correction, in which the correction data is used, on the image data of a read image obtained by reading a document by the front side reading unit 104 (or the back side reading unit 216). Specifically, when the second resolution is designated as the reading resolution and the correction data is obtained in the first mode, the image processing unit 306 performs shading correction, in which the correction data is used, on the image data of a read image generated in the second resolution by the front side reading unit 104 (or the back side reading unit 216) and outputs the corrected image data. Further, when the second resolution is designated as the reading resolution and the correction data is obtained in the second mode, the image processing unit 306 performs shading correction, in which the correction data is used, on the image data of a read image generated in the first resolution by the front side reading unit 104 (or the back side reading unit 216), performs thinning processing for converting the resolution of the image from the first resolution to the second resolution on the corrected image data, and outputs the image data after thinning processing.

As described above, the image reading apparatus 10 according to the present embodiment includes the front side reading unit 104 capable of setting at least the first resolution (e.g., 600 dpi) and the second resolution (e.g., 300 dpi), which is lower than the first resolution, as a reading resolution for reading a document conveyed from the document tray 201, and reads the document at the set reading resolution. The CPU 301 detects the width of the document placed on the document tray 201 by using the tray width guide sensor 224, for example. The CPU 301 performs the advance obtainment processing for obtaining correction data for shading correction by using the front side reading unit 104, in a state in which the document is placed in the document tray 201 and before a document read start instruction is accepted. The CPU 301 includes, as operation modes for the advance obtainment processing, the first mode for obtaining correction data by performing the advance obtainment processing using the second resolution when the second resolution is designated as the reading resolution, and the second mode for obtaining correction data by performing the advance obtainment processing using the first resolution when the second resolution is designated as the reading resolution.

Thus, for example, even when the reading resolution (e.g., the second resolution) designated by the user is different from the reading resolution (e.g., the first resolution) at the time of reading the document, it is possible to select an appropriate operation mode in accordance with the reading resolution to be actually applied at the time of reading the document (i.e., set an appropriate reading resolution) and execute the advance obtainment processing. As a result, it is possible to match the reading resolution at the time of obtaining correction data for shading correction with the reading resolution at the time of reading the document, and thus it is possible to prevent FCOT from becoming longer by redoing the processing for obtaining correction data at the start of reading of the document. Thus, according to the present embodiment, it becomes possible to appropriately set a reading resolution to be used in processing for obtaining correction data for shading correction.

### Second Embodiment

In a second embodiment, an example in which FCOT is prevented from becoming longer by stopping processing under a predetermined condition during execution of the advance obtainment processing (step S102) and starting the advance obtainment processing again will be described. In the following, descriptions for portions in common with the first embodiment will be omitted.

The processing for obtaining correction data for shading correction described in the first embodiment is performed by the CPU 301 in the following procedure.
(1) Turn on the front side reading sensor 108.
(2) Move the front side reading unit 104 to a predetermined position (HP position) below the front side white reference plate 110.
(3) Execute black sampling and adjust the black level in a state in which the front side LED 105 is turned off.
(4) Turn on the front side LED 105 and execute first white sampling.
(5) Based on a result of the first sampling, determine a threshold for extracting an anomalous point indicating staining on the white reference plate 110.
(6) Execute second sampling while moving the front side reading unit 104 within a range below the front side white reference plate 110. This is to actually extract an anomalous point and determine a correction coefficient.
(7) Move the front side reading unit 104 to the HP position again.
(8) Execute third sampling while moving the front side reading unit 104 within a range below the front side white reference plate 110. A value of the third sampling is used as a sample for actual shading correction.
(9) By performing anomalous point correction on this sample data by using the correction coefficient determined by the second sampling, generate correction data for shading correction, and store it in the shading memory 307.

Thus, in the processing for obtaining correction data for shading correction, movement of the front side reading unit 104 and a sample operation are repeatedly performed.

When the value of the tray width guide sensor 224 is determined in the middle of a respective process, if a change in document width is detected after the advance obtainment processing being executed is completed, and then the processing for obtaining correction data for shading correction is executed again after cancellation processing, FCOT becomes longer. Therefore, in the present embodiment, when it is detected that the width of a document placed on the document tray 201 is changed beyond the threshold the advance obtainment processing is being executed, it is determined to stop the advance obtainment processing being executed. Then, by re-executing the advance obtainment processing in which the reading resolution corresponding to the changed document width is applied, it is possible to prevent FCOT from becoming longer.

As a case where the advance obtainment processing is stopped, there is a case where, when setting a document having a narrow width, the user first pushes the document to the back, causing the document detection sensor 204 to respond, and after a “document present” state is entered, moves the tray width guide plate 203. In this case, it is already determined that the advance obtainment processing being executed will become invalid and will be redone later. Therefore, the CPU 301 stops the advance obtainment processing being executed.

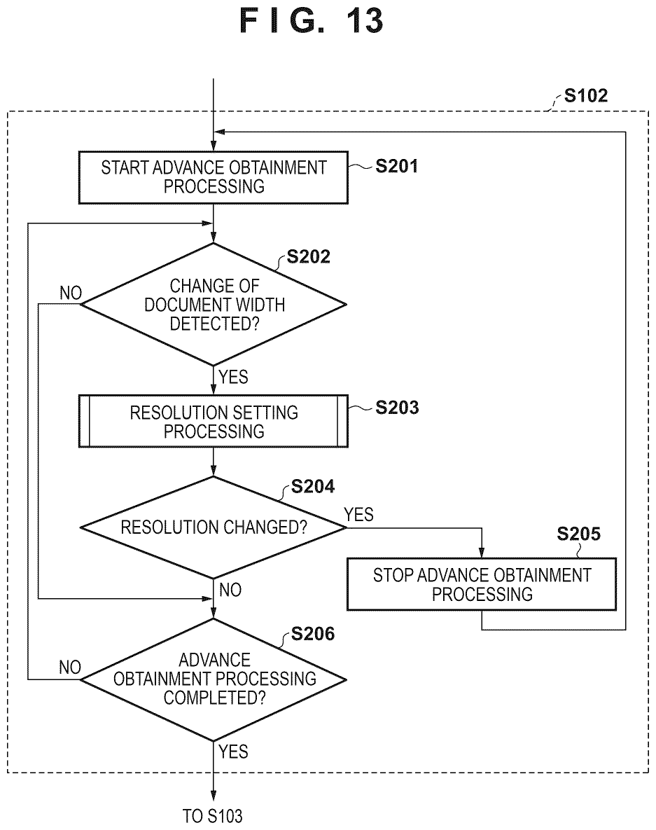

FIG. 13 is a flowchart for explaining an example of a procedure for advance obtainment processing (step S102) according to the second embodiment. In step S102, the CPU 301 starts the advance obtainment processing by using read settings included in the read setting notification (step S201). As a result, the image reading apparatus 10 transitions to a state in which completion of the advance obtainment processing is awaited. If it is detected that the document width has been changed (YES in step S202) while the advance obtainment processing is being executed, the CPU 301 executes the resolution setting processing in accordance with the procedure in FIG. 9B (step S203). If it is determined that the reading resolution setting needs to be changed as a result of executing the resolution setting processing (YES in step S204), the CPU 301 stops the advance obtainment processing being executed (step S205). Then, the advance obtainment processing is started again by using the set (changed) reading resolution, without returning the state of the image reading apparatus 10 to the standby state (step S201).

Meanwhile, even if it is detected that the document width has been changed, if there is no need to change the reading resolution setting (NO in step S204), the advance obtainment processing being executed is continued. Then, when the advance obtainment processing is completed (YES in step S206), the CPU 301 causes the image reading apparatus 10 to transition to a state in which a read start instruction is awaited, and advances the processing to step S103.

As described above, in the present embodiment, when it is detected that the width of a document has been changed during execution of the advance obtainment processing, the CPU 301 determines whether the reading resolution setting needs to be changed based on the width of the document after the change, and stops the advance obtainment processing in accordance with the result of the determination. Further, after the advance obtainment processing is stopped, the reading resolution to be used in the advance obtainment processing is set again based on the designated reading resolution and the width of the document after the change, and the advance obtainment processing is executed using the set reading resolution. This makes it possible to redo advance obtainment processing that accompanies a change in reading resolution at an earlier timing than when the advance obtainment processing being executed is continued without stopping and thereby prevent FCOT from becoming longer.

According to the present disclosure, it becomes possible to appropriately set a reading resolution to be used in processing for obtaining correction data for shading correction.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-169199, filed Sep. 27, 2024, which is hereby incorporated by reference herein in its entirety.

What is claimed is:

1. An image reading apparatus comprising:
a reading unit configured to be capable of setting at least a first resolution and a second resolution, which is lower than the first resolution, as a reading resolution for reading a document conveyed from a document tray, and read a document at a set reading resolution; and
a control unit configured to perform advance obtainment processing for obtaining correction data for shading correction by using the reading unit, in a state in which a document is placed on the document tray and before accepting a document read start instruction,
wherein the control unit includes, as operation modes for the advance obtainment processing, a first mode for obtaining the correction data by performing the advance obtainment processing using the second resolution in a case where the second resolution is designated as the reading resolution, and a second mode for obtaining the correction data by performing the advance obtainment processing using the first resolution in a case where the second resolution is designated as the reading resolution.

2. The image reading apparatus according to claim 1, further comprising:
a detection unit configured to detect a width of a document placed on the document tray;
wherein in a case where the second resolution is designated as the reading resolution, the control unit selects the first mode or the second mode based on the width of the document and performs the advance obtainment processing.

3. The image reading apparatus according to claim 2, wherein
in a case where the second resolution is designated as the reading resolution and the width of the document is below a threshold, the control unit performs the advance obtainment processing in the second mode.

4. The image reading apparatus according to claim 3, wherein
in a case where the second resolution is designated as the reading resolution and the width of the document is not below the threshold, the control unit performs the advance obtainment processing in the first mode.

5. The image reading apparatus according to claim 2, wherein
in a case where the first resolution is designated as the reading resolution, the control unit uses the first resolution in the advance obtainment processing, regardless of the width of the document.

6. The image reading apparatus according to claim 2, wherein
in a case where a change in the width of the document is detected by the detection unit after the advance obtainment processing is completed and before the start instruction is accepted, the control unit determines whether or not a setting for the reading resolution needs to be changed based on the width of the document after the change, and executes the advance obtainment processing again in accordance with a result of the determination.

7. The image reading apparatus according to claim 2, wherein
in a case where designation of the reading resolution is changed by a user after the advance obtainment processing is completed and before the start instruction is accepted, the control unit determines whether or not a setting for the reading resolution needs to be changed based on the designated reading resolution and the width of the document, and executes the advance obtainment processing again in accordance with a result of the determination.

8. The image reading apparatus according to claim 6, wherein
in a case where it is determined that the setting for the reading resolution needs to be changed, the control unit executes the advance obtainment processing again using a reading resolution after the change.

9. The image reading apparatus according to claim 2, wherein
in a case where a change in the width of the document is detected by the detection unit during execution of the advance obtainment processing, the control unit determines whether or not a setting for the reading resolution needs to be changed based on the width of the document after the change, and stops the advance obtainment processing in accordance with a result of the determination.

10. The image reading apparatus according to claim 9, wherein
in a case where it is determined that the setting for the reading resolution needs to be changed during execution of the advance obtainment processing, the control unit stops the advance obtainment processing.

11. The image reading apparatus according to claim 10, wherein
after the advance obtainment processing is stopped, the control unit sets a reading resolution to be used in the advance obtainment processing again based on the designated reading resolution and the width of the document after the change, and executes the advance obtainment processing by using the set reading resolution.

12. The image reading apparatus according to claim 1, wherein
in a case where a predetermined time elapses after the advance obtainment processing is completed and before the start instruction is accepted, the control unit discards the correction data obtained by the advance obtainment processing.

13. The image reading apparatus according to claim 2, wherein
the control unit obtains a reading resolution designated by a user via a setting screen displayed on a display unit before the start instruction is accepted, and sets a reading resolution to be used in the advance obtainment processing based on the obtained reading resolution and the width of the document.

14. The image reading apparatus according to claim 1, further comprising:
a processing unit configured to perform shading correction in which the correction data is used, on image data of a read image obtained by the reading unit reading a document,
wherein the processing unit
in a case where the second resolution is designated as the reading resolution and the correction data is obtained in the first mode, performs shading correction in which the correction data is used, on image data of the read image generated by the reading unit in the second resolution, and outputs image data after the shading correction, and
in a case where the second resolution is designated as the reading resolution and the correction data is obtained in the second mode, performs shading correction in which the correction data is used, on image data of the read image generated by the reading unit in the first resolution, performs thinning processing for converting a resolution of an image from the first resolution to the second resolution on image data after the shading correction, and outputs image data after the thinning processing.
